(19) United States
(12) Patent Application Publication
(10) Pub. No.: US 2011/0260441 A1
(43) Pub. Date: Oct. 27, 2011

(54) METHOD AND DEVICE FOR APPLYING AT LEAST ONE IMAGE TO A PLASTIC SUBSTRATE OF A SECURITY DOCUMENT, SECURITY DOCUMENT HAVING A PLASTIC SUBSTRATE WHICH BEARS AN IMAGE

(75) Inventors: Dominik Graf, Nabburg (DE); Tobias Vitzthum, Schonthal (DE)

(73) Assignee: Muehlbauer AG, Roding (DE)

(21) Appl. No.: 13/120,853

(22) PCT Filed: Sep. 25, 2009
(86) PCT No.: PCT/EP09/06952

§ 371 Date: Jun. 16, 2011

(30) Foreign Application Priority Data
Sep. 26, 2008 (DE) 10 2008 049 154.3

(51) Int. Cl. B42D 15/00; B65C 9/46; B32B 38/14

(52) U.S. Cl. 283/72; 156/277; 156/356; 156/388

(57) ABSTRACT

A method for applying at least one image to a plastics substrate of a security document, comprising the following steps: selection of an image section from electronically stored image data of an image by means of a selection device; application of a connecting layer to the plastics substrate, the surface area and surface shape of the connecting layer corresponding to the surface area and surface shape of the selected image section, by means of an application device; and printing the applied connecting layer with a printed image that reproduces the image section, in such a manner that the connecting layer and the printed image are congruent, by means of a printing device.

### CROSS-REFERENCE TO RELATED APPLICATIONS

This application is a National Stage of International Application No. PCT/EP2009/006952, filed Sep. 25, 2009, which claims the priority of German Patent Application Serial No. DE 10 2008 049 154.3, filed Sep. 26, 2008.

### DESCRIPTION

### Background

A method and a device for applying at least one image to a plastics substrate of a security document are disclosed. In addition, a security document having a plastics substrate which bears such an image is disclosed.

Security documents, such as, for example, cards, in particular chip cards and smart cards of government institutions (passport, visa authorities), banks (debit cards, credit cards), insurers (health insurance cards) or loyalty cards, etc., require their surface to be printed in order to apply to that surface personal data and identifying features, such as, for example, a portrait image of the person. In addition, numerous security features are usually applied to such card surfaces.

Such cards in most cases consist of a plastics material, which can also have a multi-layer structure. The surfaces of such plastics materials, such as, for example, polycarbonate, are usually such that they do not permit direct printing by means of conventional printing devices for the application of, for example, an image or other personal data with the necessary permanent adhesion of the printing ink to the card material. In fact, in the case of such plastics cards, the prior application of a connecting layer, such as, for example, a precoating layer (connecting layer), is conventional in order to make the printed image, and accordingly the printing ink, on the surface of the card substrate, or of the plastics card, durable for a long time, that is to say to make it adhere thereto for a long time.

### PRIOR ART

Such precoating layers have hitherto been applied uniformly, for example in rectangular or square form, approximately at the location of the security document card in which a printed image with a picture of the person who is to receive the card is later to be printed. Such precoating layers exhibit a uniform surface shape with a simple geometric form (for example rectangular or square), which is substantially larger than the head of a person in a portrait picture and, optionally, his head and shoulders. For the sake of simplicity, such a passport photograph, which includes not only the head and the neck and shoulders but also a background portion which is produced when the image of the person is recorded, is applied in its entirety to the precoating layer. The image portions, or image sections, that represent the background in the passport photograph require unnecessary application and printing times for the application of the precoating layer and printing with the printed image. It is also conceivable for the security document card to contain images or motifs other than a photograph of a person: for example, a logo or mark of the institution issuing the security document card, the emblem of the country in question, a health symbol or a tree on health cards or health insurance cards.

From DE 10 2006 059 855 A1 and from DE 10 2005 0r28 161 A1 there is known a portable data carrier in multi-layer form having a core layer and an image-receiving layer. Graphic information is applied to the image-receiving layer by transfer thermography. The image-receiving layer is transparent and a transparent composite of a carrier layer and an acceptor layer. The carrier layer consists substantially of an amorphous polyester, in particular PETG. The acceptor layer consists substantially of a mixture of PETG with at least 10 wt. % of a polymer from the group of the styrene polymers. The composite is a singe foil produced by coextrusion. The styrene polymer contained in the acceptor layer is a polymer from the group of the styrene copolymers, in particular acrylonitrile-styrene-acrylate. The carrier layer is made of polycarbonate.

From WO/2000/073088 A1 there is known a recording medium with coloured image information, in which the coloured image information is applied by a thermal process (thermal sublimation or thermal transfer) to a surface, which has been treated to render it adhesive, of a layer of polycarbonate. An adhesion-promoting, solvent-containing screen printing lacquer is applied to the surface. At least the coloured image information is covered with a protective layer of a foil or a solvent-containing screen printing lacquer. Beneath or above the coloured image information there is arranged a black-and-white portion of the coloured image information, the black-and-white portion being introduced by means of a laser printer while preserving the coloured image information in its entirety.

### Problems of the Prior Art

Insofar as such a method for applying an image to a plastics substrate is integrated into a device for personalising a large number of security documents, thermal printing devices are used for the actual printing operation, which devices require a large amount of time and a large amount of precoating material for the application of the additional background portions for the precoating layer and printing of the additional background portions. This reduces the throughput of the personalisation device as a whole.

In addition, such additional background surface portions often disadvantageously exhibit an unattractive surface, in particular when the precoating layer is not printed with the personal passport photograph in certain regions, optionally in the entire region of the background image portion.

Furthermore, such areas printed with background surface portions require space on the security document card. As a result, that space is not available for the application of other data, such as, for example, further security features in the form of holograms or lettering. Because the surface of a conventional security document card in the conventional card formats is not very large anyway, the printable surface portion of the card is available to only a limited extent.

In addition to this, such relatively large areas require long heating times in a thermal printing process that is to be used, for example by means of a thermode, which in turn results in a low throughput for the device as a whole.

### Underlying Object

This gives rise to the object of providing a method and a device for applying at least one image to a plastics substrate of a security document, with which rapid application of image sections relevant for the security document is possible.

### Solution

In a method for applying at least one image to a plastics substrate of a security document, the following steps can be carried out:

selection of an image section from electronically stored image data of an image;

application of a connecting layer to the plastics substrate, the surface area and surface shape of the connecting layer corresponding or almost corresponding to the surface area and surface shape of the selected image section; and

printing the applied connecting layer with a printed image that reproduces the image section, in such a manner that the connecting layer and the printed image are congruent or at least almost congruent.

The selection of the image section that is relevant for the security document from electronically stored image data of an image can be carried out by means of a selection device. The selection device is able to detect, for example by means of pre-specified contours, the head, neck and shoulders of a person depicted in a passport photograph and release them from the background. Application of the connecting layer (precoating layer) to the plastics substrate can be carried out by means of an application device which applies the connecting layer to the plastics substrate in the form of a foil, or the like. Preferably it is a solid material, preferably a thermal transfer ribbon, which is marketed, for example, by Imperial Chemical Industries Limited under the name Unichroma. Printing of the applied connecting layer with the image section can be carried out by means of a printing device. The printing device applies the image by thermal printing, by transfer printing, by ink-jet printing, laser printing, thermal sublimation printing or the like. In the case of thermal sublimation printing, a carrier foil coated with ink wax is passed over a strip having heating elements (thermodes), which heat the ink wax to approximately from 300 to 400° C. without delay, so that the wax becomes detached from the foil and changes from the solid to the gaseous state. On evaporation, the ink bonds completely to the connecting layer so that there is no perceptible ink layer as in the case of ink-jet or laser printing, for example. It is thereby possible to print a photo-realistic image in four passes (cyan, magenta, yellow), a colourless fixing layer being applied to the finished image on the fourth pass. As a result, the image is extremely resistant to environmental influences such as, for example, scratches or moisture.

The colourless fixing layer serves as the protective layer/overlay. Such a protective layer can be applied either to the entire surface of the plastics substrate or in the form of the image of the head and, optionally, of the neck and shoulders of a person depicted in a passport photograph.

For example, the head and, optionally, the neck and shoulders of a person depicted in a passport photograph, or other image sections relevant for the security document, which are electronically cropped beforehand by means of an image processing program, and only the image section resulting therefrom applied with a limited area. By means of this measure, the printing time and heating time when using a thermal printing process can be reduced. Corresponding advantages are also obtained in other printing processes. Likewise, the connecting layer (precoating layer) is applied beforehand over a surface extent which preferably corresponds exactly or almost exactly to the surface extent, or surface area, and the surface shape of the previously cropped image section. Accordingly, no further surface portions of the plastics substrate outside the image portion that contains the head and, optionally, the neck and shoulders are provided with a precoating layer on the plastics substrate. This has the result that those portions of the connecting layer on the surface of the plastics substrate can no longer have a disadvantageous appearance and, at the same time, the area is available for other security features or the like because—unlike in the prior art—those portions of the connecting layer are no longer present here.

The image section, as regards a passport photograph or portrait photograph, is accordingly reduced to the minimum required portions of the photograph, namely the head and, optionally, the neck and shoulders. Such a minimised surface portion of the precoating layer and of the printed area of the printed image on the security document requires shorter heating times during a thermal printing process, for example. Thus, a higher throughput is possible in a personalisation device which, for example, carries out such a thermal printing process together with the application of the connecting layer to the surface of the security document. Overall, this results in a device which works faster, and accordingly in the production of a higher number of security document cards having a printed personal image per unit time.

According to a preferred embodiment, the step of selecting an image section from electronically stored image data comprises the step/steps of determining differences in colour between individual image regions and/or differences in brightness between individual image regions and/or lines between the individual image regions in the electronically stored image by means of a determination device. Thus, for example, the difference between the actual head of the person and the background, which is kept light, can be determined, and the head can subsequently be separated from the background electronically or the person's head can be cut out. In this manner, a contour of the person's head and, optionally, of the neck and shoulders can be determined and, on the basis of that contour or surface shape, the image section representing the person can be separated from the background portion.

On the basis of the differences in colour and/or differences in brightness and/or lines so determined it is possible to calculate a large number of surface position data of a selected image section within the electronically stored image. This is carried out using a calculation device. Such surface position data reproduce the surface shape and surface area of the image section within the image as a whole and allow the desired or selected image section to be defined in terms of data in a manner suitable for control or regulation.

The surface position data are transmitted to a first control or regulating device of the application device as well as to a second control or regulating device of the printing device.

The first control or regulating device receives the surface position data and, in the step of applying the connecting layer, controls or regulates the application device in such a manner that the connecting layer is applied, with the transmitted surface position and surface extent data, to a surface of the plastics substrate. Accordingly, not too much, but also not too little, material for the connecting layer is applied, because the connecting layer as a result exhibits exactly or at least almost exactly the surface area and surface shape of the person's head, optionally with the neck and shoulders, that is subsequently to be printed thereon. The expression “exhibit exactly or at least almost exactly the surface area and surface shape of the person's head that is subsequently to be printed thereon” is understood as meaning that the connecting layer has a surface content which is not more than from about 3% to about 10% greater than the surface content of the printed image. In addition, the connecting layer can have a shape and dimensions which virtually coincide with those of the person's head that is subsequently to be printed thereon but protrude slightly (from approximately 1% to approximately 10%) in all directions beyond the image of the person's head that is to be printed.

The connecting layer or precoating layer can contain as material polyester-based compounds which allow permanent durability of the printing ink on the card substrate material, which can consist, for example, of polycarbonate, to be ensured.

The surface position data are likewise transmitted to the second control or regulating device of the printing device. The second regulating device controls or regulates the printing device in such a manner that the printed image is applied, with the surface position data applied thereto, to the entire area of a surface of the connecting layer. In this manner, on the one hand no portions of the plastics substrate that have not previously been provided with a connecting layer are printed. On the other hand, no portions of the connecting layer are left without printing ink, because both the first and the second control or regulating devices have received the same surface position data.

A device for carrying out such a method has the selection device for selecting the image section from the electronically stored image data of the image, the application device for applying the connecting layer to the plastics substrate, the surface area and surface shape of the connecting layer corresponding to the surface area and surface shape of the selected image section, and the printing device for printing the applied connecting layer with the printed image that reproduces the image section, in such a manner that the connecting layer and the printed image are congruent or almost congruent or cover the entire area or almost the entire area.

Such a device additionally has the first and second control or regulating devices, the determination device and the calculation device, the functions of which have already been described.

The first and second control and regulating devices or parts thereof can be combined in a common control device, for example an electronic data processing system, the function of which can be controlled by computer programming software.

A plurality of printing devices (for coloured images: yellow, magenta, cyan, black) for the connecting and/or overlay layers are controlled or regulated by one or more control or regulating devices. In other words, at least one printing device is controlled or regulated by at least one control or regulating device.

A plurality of control and/or regulating devices is possible for carrying out the respective functions. The one or more control and/or regulating device(s) can be designed, produced and implemented together or separately.

Further advantageous embodiments will become apparent from the dependent claims.

### BRIEF DESCRIPTION OF THE DRAWINGS

Further objects, features, advantages and possible uses will become apparent from the following description of embodiments, which are not to be interpreted as being limiting, and the accompanying drawings. All the features described and/or shown in the figures form the subject-matter disclosed herein on their own or in any desired combination, independently of their grouping in the claims or their dependencies.

FIG. 1 shows, in diagrammatic form, five sequence steps by means of the representation of an image of a person for carrying out the method.

FIG. 2 shows, in a flow diagram, a possible sequence of the method.

### DETAILED DESCRIPTION OF THE DRAWINGS

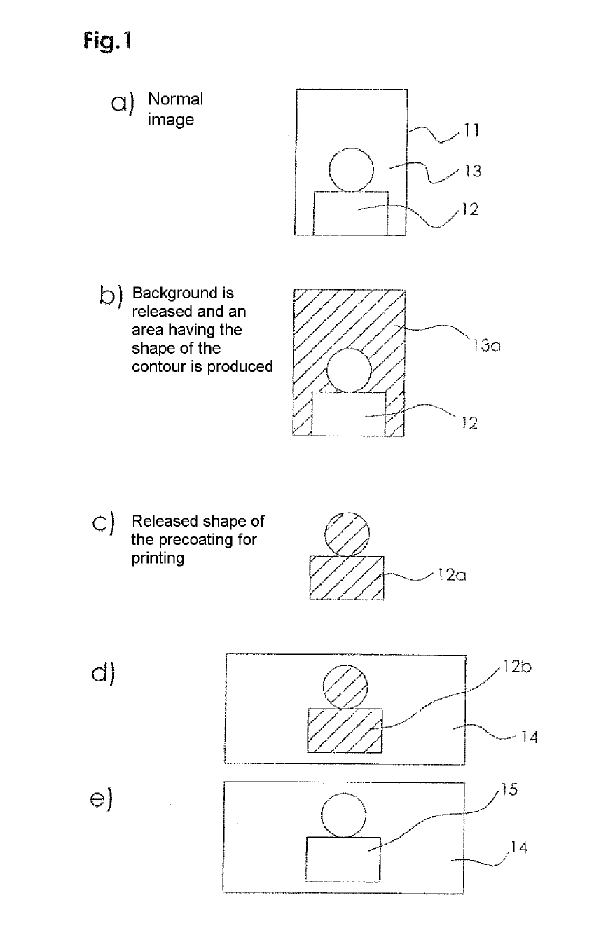

FIG. 1 shows a diagrammatic representation of an image processing method for carrying out the method.

In a first step a, a normal image 11, such as, for example, a passport photograph, containing a person 12 and a background portion 13 is detected and digitised in an electronic data processing system.

In a step b, by means of image data processing software in the electronic data processing system, the background portion 13 of the image is detected in the digitised image 11 on the basis of differences in colour and/or differences in brightness and/or lines or contours, and is marked as such, as is also shown by the reference numeral 13a. The contours or the surface shape of the representation of the actual person, namely of the head and of the neck and shoulders of the person 12, are thereby worked out and can be released in the digitised image.

In step c, by means of the image data processing software in the electronic data processing system, the background 13a is erased or “electronically cropped” from the digitised image 11 in order to obtain a residual image section template 12a which depicts only the person. The image section template 12a is, for example, electronically produced and stored as surface position data by the image data processing software in the electronic data processing system. Accordingly, the image section template 12a can be passed both to an application device for application of the connecting layer and to a printing device for printing of the connecting layer with the printed image that reproduces the image section. Advantageously, both the application device and the printing device can be integrated in a common thermode printing device.

Then, in step d, on the basis of the transmitted surface position and/or surface dimension data, the image section 12a is transferred by the application device to a plastics substrate 14 of a security document card. The connecting layer 12b is thus permanently arranged on the surface of the plastics substrate, with that surface area and the surface shape of the image section 12a. The plastics substrate 14 can contain one material or a plurality of materials from the group polyethylene (PE), polyvinyl chloride (PVC), polyethylene terephthalate (PET) or glycol-modified polyethylene terephthalate (PETG), polyethylene naphthalate (PEN), acrylonitrile-butadiene-styrene copolymer (ABS), polyvinylbutyral (PVB), polymethyl methacrylate (PMMA), polyimide (PI), polyvinyl alcohol (PVA), polystyrene (PS), polyvinylphenol (PVP), polyethylene (PE), polypropylene (PP) or polycarbonate (PC).

Then, in a step e, the actual image printing operation on the plastics substrate 14 takes place. In this step, the entire area and extent of the connecting layer 12b is printed with the printed image 15 that reproduces the person. The connecting layer 12b is then covered by the printed image 15. This is achieved in that the entire area of the connecting layer 12b is covered exactly with the printed image 15 and, as a result, there are no laterally protruding connecting layer portions or laterally protruding printed image portions.

As the final step, a protective layer can be applied to the image section that reproduces the printed image 15, the protective layer being applied either to the entire surface of the plastics substrate having the printed image 15 or only in the form of the printed image 15.

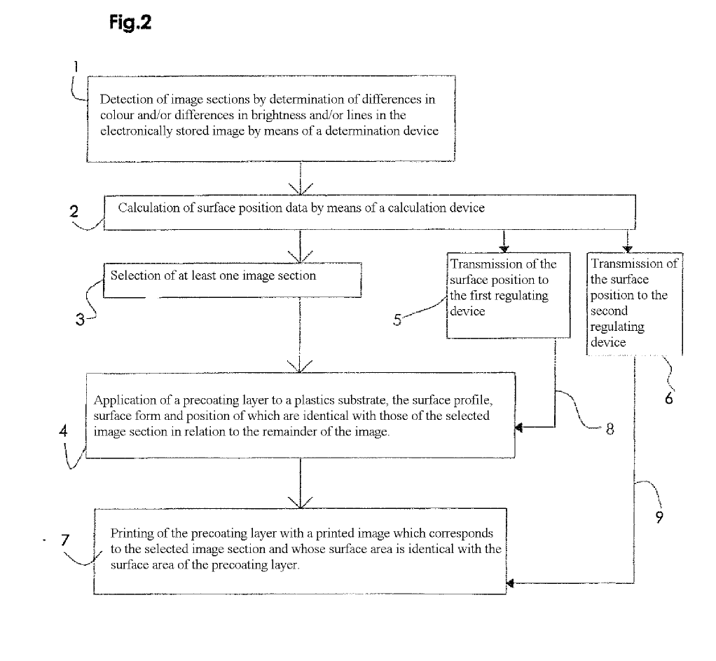

FIG. 2 shows the sequence of the method. In a first step 1, the detection of image sections takes place by the determination of differences in colour and/or differences in brightness and/or lines in the electronically stored image by means of a determination device and an image data processing system. The primary aim of the detection of image sections in this manner is—as already explained in FIG. 1—to separate the contours of a person from the background surface portions.

In a step 2, surface position data are calculated by means of a calculation device, the surface position data preferably reproducing the position data of the selected image section.

In a step 3, the selection of the actual image section then takes place, that is to say in this case the selection of those surface portions in the image which reproduce the actual person and the contour. At the same time, the surface position data are transmitted to a first control or regulating device, which is connected to an application device, and to a second control or regulating device, which is connected to a printing device, according to steps 5, 6.

In a fourth step, the precoating layer is applied to the plastics substrate on the basis of the calculated position data, the surface area, the surface shape and the positioning of the precoating layer on the security document card preferably being identical with those of the selected image section in relation to the remainder of the image.

Such a surface-exact application of the precoating layer is carried out by means of the first control or regulating device 8 in such a manner that the first control or regulating device controls or regulates the positioning and the sequence of the application operation of the connecting layer in relation to the application device.

Likewise, the second control or regulating device regulates the printing device according to step 9, in such a manner that, in a step 7, the precoating layer is printed with a printed image which corresponds to the selected image section and whose surface area is identical with the surface area of the precoating layer.

Such a printing operation should, therefore, take place in such a manner that the connecting layer applied previously is covered exactly by the printed image, neither connecting layer portions nor layer portions of the printed image protruding laterally with respect to the other layer. Both the heating times in a thermal (transfer) printing process and the processing times of the device as a whole can thus be reduced considerably. In addition, further surface portions of the card substrate are available for the application of further features, for example security features, when the background portions of the passport picture have not also been transferred to the card substrate or plastics substrate.

There is thus obtained a security document having a plastics substrate 14 which bears an image, wherein an image section 12, 12a of an image 11, 12, 13 is applied to the security document. Between the image section 12, 12a of the image 11, 12, 13 and the plastics substrate 14, a connecting layer 12b is applied to the plastics substrate 14, the surface area and surface shape of the connecting layer 12b corresponding or almost corresponding to the surface area and surface shape of the selected image section 12, 12a, so that the connecting layer 12b and the printed image 15 are congruent or almost congruent.

The connecting layer 12b has a surface content which is not more than from about 1% to about 10%, for example about 5%, greater than the surface content of the printed image 15. The connecting layer 12b in this case protrudes approximately uniformly from the printed image along its edge.

Although the product, device and method details discussed above have been described in combination, it is pointed out that they are also independent of one another and can also be freely combined with one another. The relationships of the individual parts and sections thereof to one another shown in the figures, and their dimensions and proportions, are not to be interpreted as being limiting. In fact, individual dimensions and proportions can also differ from those shown.

1. A method for applying at least one image to a plastic substrate of a security document, comprising the steps:
selection of an image section from electronically stored image data of an image;
application of a connecting layer to the plastic substrate, a surface area and surface shape of the connecting layer corresponding or almost corresponding to a surface area and surface shape of the selected image section; and
printing of the applied connecting layer with a printed image that reproduces the image section, in such a manner that the connecting layer and the printed image are congruent or almost congruent.

2. The method according to claim 1, wherein selecting an image section from the electronically stored image data comprises determining differences in colour between individual image areas and/or differences in brightness between individual image areas and/or lines between individual image areas in the electronically stored image data by a determination device.

3. The method according to claim 2, wherein, on the basis of the determined differences in colour and/or differences in brightness and/or lines, surface position data of the image section of the electronically stored image data that is to be selected is calculated by a calculation device.

4. The method according to claim 3, wherein the surface position data is transmitted to a first regulating device of an application device.

5. The method according to claim 4, wherein when applying the connecting layer, the first regulating device controls or regulates the application device in such a manner that the connecting layer is applied, with the transmitted surface position data, to a surface of the plastic substrate.

6. The method according to claim 3,
wherein the surface position data is transmitted to a second regulating device of a printing device.

7. The method according to claim 6,
wherein the second regulating device controls or regulates the printing device in such a manner that the printed image is applied, with the surface position data applied thereto, to an entire area or almost the entire area of a surface of the connecting layer.

8. The method according to claim 1,
wherein the image section represents a head and, optionally, a neck and shoulder region of a person within a portrait photograph.

9. The method according to claim 1,
wherein the connecting layer is a precoating layer, of a polyester-containing material.

10. The method according to claim 1,
wherein a protective layer is applied to the image section that reproduces the printed image, the protective layer being applied either to all of the plastic substrate having the printed image or only a form of the printed image.

11. An apparatus comprising:
a selection device for selecting an image section from electronically stored image data of an image,
an application device for applying (4) a connecting layer to a plastic substrate, wherein a surface area and surface shape of the connecting layer corresponds to a surface area and surface shape of the selected image section, and
a printing device for printing the applied connecting layer with a printed image that reproduces the image section, in such a manner that the connecting layer and the printed image are congruent or almost congruent.

12. The apparatus according to claim 11, further comprising a determination device for determining differences in colour between individual image regions and/or differences in brightness between individual image regions and/or lines of individual image regions in the electronically stored image data; a first regulating device for regulating the application device in such a manner that the connecting layer is applied, with received surface position data, to a surface of the plastic substrate, and a second regulating device for regulating the printing device are so arranged that the printed image is applied, with surface position data applied thereto, to an entire area or almost the entire area of a surface of the connecting layer.

13. The apparatus according to claim 12, wherein the first and second regulating devices are combined to form a single control or regulating device.

14. A security document having a plastic substrate which bears an image, wherein an image section of the image is applied to the security document and, between the image section of the image and the plastic substrate, a connecting layer is applied to the plastic substrate, and wherein a surface area and surface shape of the connecting layer corresponds to a surface area and surface shape of the selected image section, so that the connecting layer and the printed image are congruent or almost congruent.

15. The security document according to claim 14, wherein the connecting layer has a surface content which is not more than about 1% to about 10% greater than a surface content of the printed image, and/or wherein a protective layer is applied to the image section that reproduces the printed image, where the protective layer is either applied to an entire surface of the plastic substrate having the printed image or is applied thereto only a form of the printed image.
